(19) United States
(12) Patent Application Publication
(10) Pub. No.: US 2025/0283502 A1
(43) Pub. Date: Sep. 11, 2025

(54) NUT PLATE ASSEMBLY INCLUDING FLOATING NUT WITH LOCKING ARRANGEMENT

(71) Applicant: Enduralock, LLC, Lenexa, KS (US)

(72) Inventors: Armando Perez, III, Los Angeles, CA (US); Igor Komsitsky, Los Angeles, CA (US)

(21) Appl. No.: 18/764,958

(22) Filed: Jul. 5, 2024

Related U.S. Application Data
(60) Provisional application No. 63/525,558, filed on Jul. 7, 2023.

(51) Int. Cl. F16B 37/04; F16B 5/02

(52) U.S. Cl. CPC F16B 37/044; F16B 5/025

(57) ABSTRACT

A nut plate assembly includes a plate comprising an aperture defined therethrough, and a shell attached to the plate and extending along a center axis. The nut plate also includes a nut disposed within the shell. The nut is tiltable relative to the center axis when the nut is retained within the shell. A fastener is received within the nut plate assembly and engages the nut when the fastener is in a locked orientation. The nut includes an engagement surface that engages the fastener when the fastener is in the locked orientation.

### CROSS-REFERENCE TO RELATED APPLICATION

This application claims priority to U.S. Provisional Patent Application No. 63/525,558, filed on Jul. 7, 2023, the entire content of which is incorporated by reference.

### STATEMENT ON FEDERALLY SPONSORED RESEARCH AND DEVELOPMENT

This invention was made with government support under contract number FA864922P0854 awarded by the U.S. Air Force Small Business Innovation Research (SBIR) program Phase II. The government has certain rights in the invention.

### BACKGROUND

The field of the disclosure relates generally to nut plates, and more specifically to nut plate assemblies including a floating nut that provides a quarter-turn locking arrangement with a fastener.

At least some known floating nut plate assemblies include a base or bottom plate with an opening. The nut plate assemblies support a nut or similar fastener element that is captured on the base by a retainer or cage component. Such nut plates facilitate holding components, for example panels, together when a fastener is engaged with the nut and tightened, while still enabling some movement between the components. In such known nut plates, the nut receives a fastener, such as a bolt, screw, or other threaded component element passed through an opening in the components and threaded into the nut. The opening in the component may be sized to enable the nut and fastener to move laterally to accommodate some movement between the fastened components. However, the floating nut plates may not provide sufficient tolerances or account for misalignment of the fastener and the floating nut plate. In addition, the fastener may need to be screwed into the nut to provide a desired level of tightness. However, it may be difficult to rotate the fastener the required amount and/or determine if the fastener is sufficiently tightened.

At least some known floating nut plates may be used in the aerospace industry. In aerospace applications, the types and numbers of fasteners for a panel assembly can be significant. Some panel fasteners for a particular panel assembly may have different lengths, while otherwise looking similar to other panel fasteners. When the panel assembly is removed, a user may typically place all the panel fasteners in a separate location to keep from misplacing the fasteners. However, when replacing the panel assembly, the user may inadvertently use an incorrect length fastener for a particular panel fastener location. This can lead to an improperly attached panel assembly.

Accordingly, there is a need for a nut plate assembly that provides a secure connection between two panels and is simple to install. In addition, the nut plate assembly should accommodate misalignment of the fastener and the nut.

### BRIEF DESCRIPTION

In one aspect, a nut plate assembly includes a plate comprising an aperture defined therethrough, a shell attached to the plate and extending along a center axis, and a nut retained within the shell and comprising an inner surface and an engagement surface that extends at an angle relative to the inner surface. The inner surface defines an inner bore and has a groove extending along the inner bore and parallel to the center axis. The nut plate assembly is configured to receive a fastener extending through the aperture of the plate and into the inner bore in the nut. In an unlocked orientation, the fastener is configured to move through the groove. In a locked orientation, the engagement surface engages the fastener and prevents the fastener moving axially relative to the floating nut.

In another aspect, a fastener assembly includes a plate comprising an aperture defined therethrough, a shell attached to the plate and extending along a center axis, a nut retained within the shell and comprising an inner bore, a fastener extending through the plate and into the shell to engage the nut, and a bias member disposed within the shell and engaged with the nut. The fastener is rotatable between an unlocked orientation and a locked orientation when the fastener is engaged with the nut. The nut includes an engagement surface that engages the fastener when the fastener is in the locked orientation. The unlocked orientation and the locked orientation are 90° apart.

In yet another aspect, a method of assembling a nut plate assembly includes positioning a nut within a shell extending along a center axis. The nut comprises an inner surface and an engagement surface that extends at an angle relative to the inner surface. The inner surface defines an inner bore and has a groove extending along the inner bore and parallel to the center axis. The method also includes coupling a plate to the shell to capture the nut within the shell. The plate comprises an aperture arranged to receive a fastener such that the fastener extends through the plate and into the shell to engage the nut. In an unlocked orientation, the fastener is configured to move through the groove. In a locked orientation, the engagement surface engages the fastener and prevents the fastener moving axially relative to the floating nut.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of a nut plate assembly;

FIG. 2 is another perspective view of the nut plate assembly;

FIG. 3 is a side view of the nut plate assembly;

FIG. 4 is a bottom view of the nut plate assembly;

FIG. 5 is a perspective view of a portion of the nut plate assembly including a bias member, a shell, and a nut;

FIG. 6 is a perspective view of the shell;

FIG. 7 is a rear perspective view of the shell showing an inner cavity of the shell;

FIG. 8 is a side view of the shell;

FIG. 9 is a perspective view of a plate of the nut plate assembly;

FIG. 10 is a perspective view of the nut;

FIG. 11 is a bottom view of the nut;

FIG. 12 is cross-section view of the nut, taken along line A-A in FIG. 11;

FIG. 13 is a perspective view of the bias member;

FIG. 14 is a side view of the bias member;

FIG. 15 is a top view of the bias member;

FIG. 16 is a perspective view of a fastener assembly including the nut plate assembly and a fastener;

FIG. 17 is a sectional view of the fastener assembly showing the nut tilting to accommodate an orientation of the fastener;

FIG. 18 is a perspective view of the nut plate assembly, coupled to a mounting structure and a panel;

FIG. 19 is a rear perspective view of the mounting structure and the panel illustrating a fastener extending through the mounting structure and the panel and engaging the nut plate assembly;

FIG. 20 is a cross-sectional view of the nut plate assembly coupled to the mounting structure and the panel, and including the captive fastener;

FIG. 21 is a top view of an example nut plate assembly, illustrating example dimensions of the nut plate assembly;

FIG. 22 is a side view of the nut plate assembly;

FIG. 23 is a cross-sectional view of the nut plate assembly taken along line B-B shown in FIG. 21;

FIG. 24 is a side view of an example fastener, illustrating example dimensions of a fastener;

FIG. 25 is another side view of the fastener shown in FIG. 24; and

FIG. 26 is an end view of the fastener shown in FIG. 24, illustrating an example head of the fastener.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms such as “about,” “approximately,” and “substantially” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

Relative descriptors used herein such as upward, downward, left, right, up, down, length, height, width, thickness, and the like are with reference to the figures, and not meant in a limiting sense. Additionally, the illustrated embodiments can be understood as providing exemplary features of varying detail of certain embodiments, and therefore, features, components, modules, elements, and/or aspects of the illustrations can be otherwise combined, interconnected, sequenced, separated, interchanged, positioned, and/or rearranged without materially departing from the disclosed fastener assemblies. Additionally, the shapes and sizes of components are also exemplary and can be altered without materially affecting or limiting the disclosed technology.

The nut plate assemblies described herein overcome many of the problems associated with nut plate assemblies. In general, nut plate assemblies are used to fixedly connect panels to structures in a variety of applications such as, without limitation, aerospace applications, industrial applications, and building applications, where access to both sides of the nut plate assembly is limited or restricted. Among other features and benefits, the disclosed nut plate assemblies facilitate one or more of the use of captive panel fasteners having varying lengths, quick and easy installation and/or removal of panel fasteners, and/or single end access for blind fastening applications. In addition, nut plate assemblies described herein can accommodate fasteners that are misaligned with a center axis of the nut plate assemblies. Also, nut plate assemblies described herein are simpler to use and provide a secure connection. The advantages, and other features of the technology disclosed herein, will become more readily apparent to those having ordinary skill in the art from the following detailed description of certain preferred embodiments taken in conjunction with the drawings.

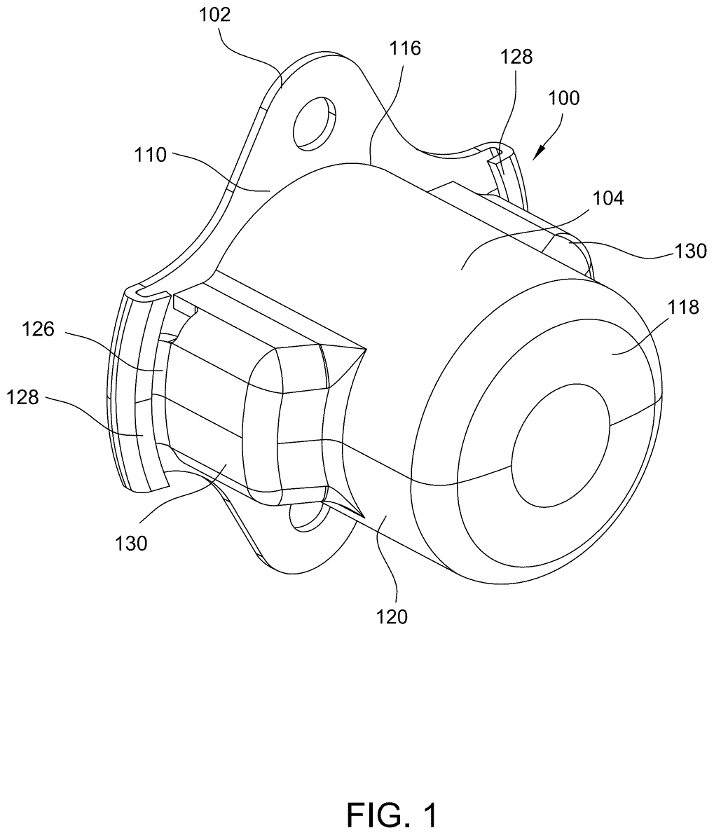

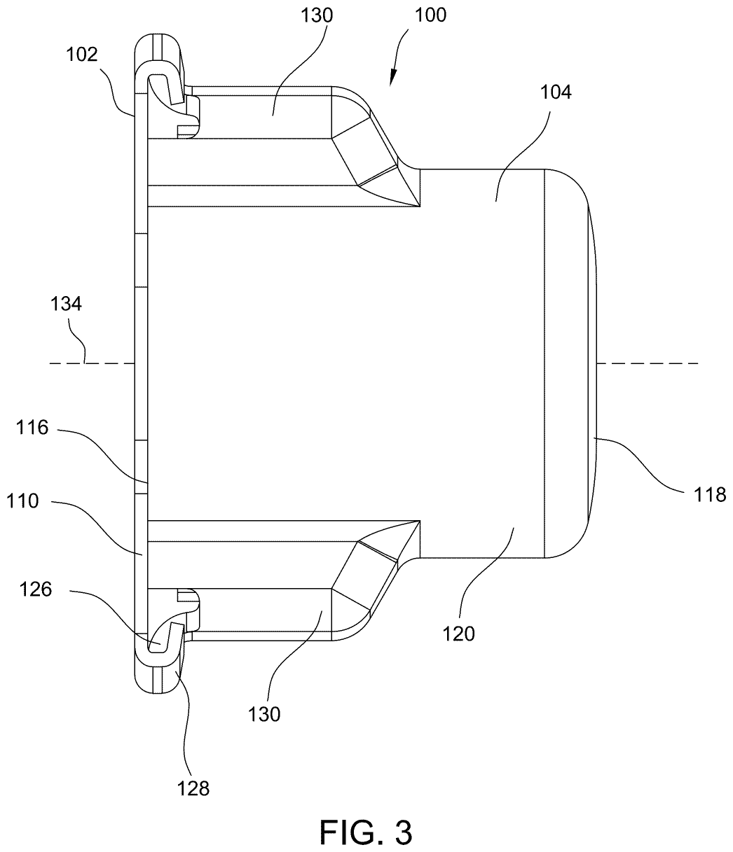

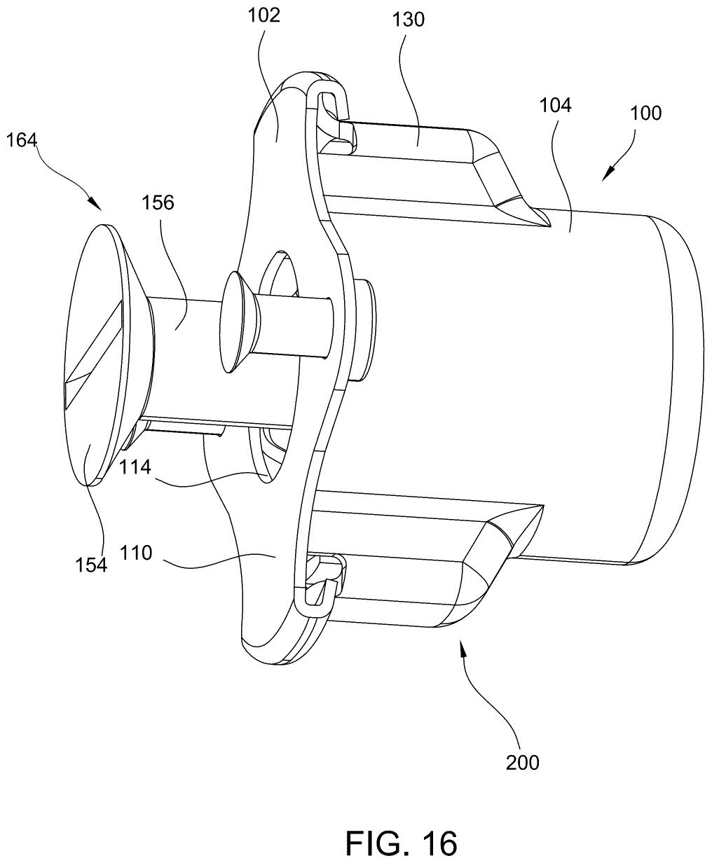

FIGS. 1-4 illustrate an example nut plate assembly. In the example, the nut plate assembly 100 includes a plate 102, a shell 104, a floating nut, broadly a nut, 106, and a bias member 108. The plate 102 includes a wall 110. The wall 110 defines an aperture 114 for receiving a fastener (e.g., fastener 164 shown in FIGS. 16-20).

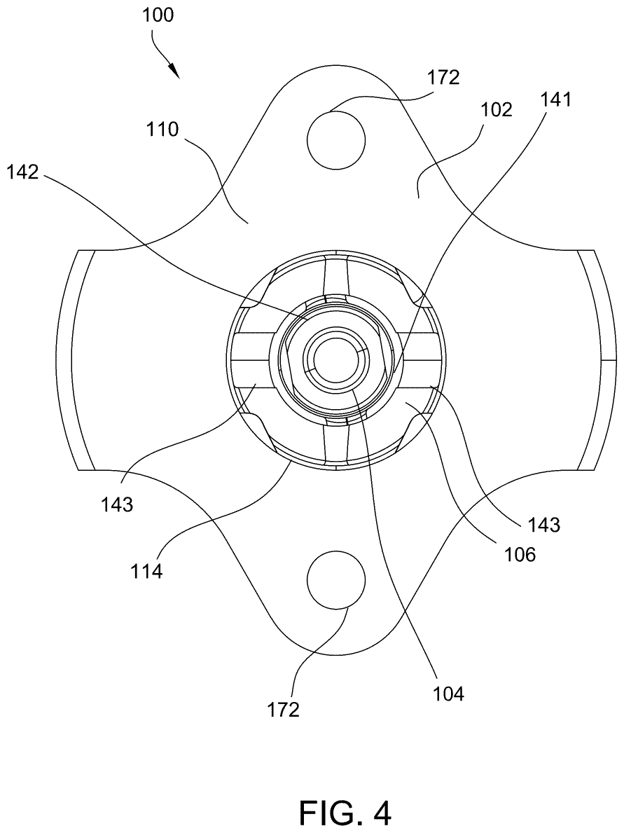

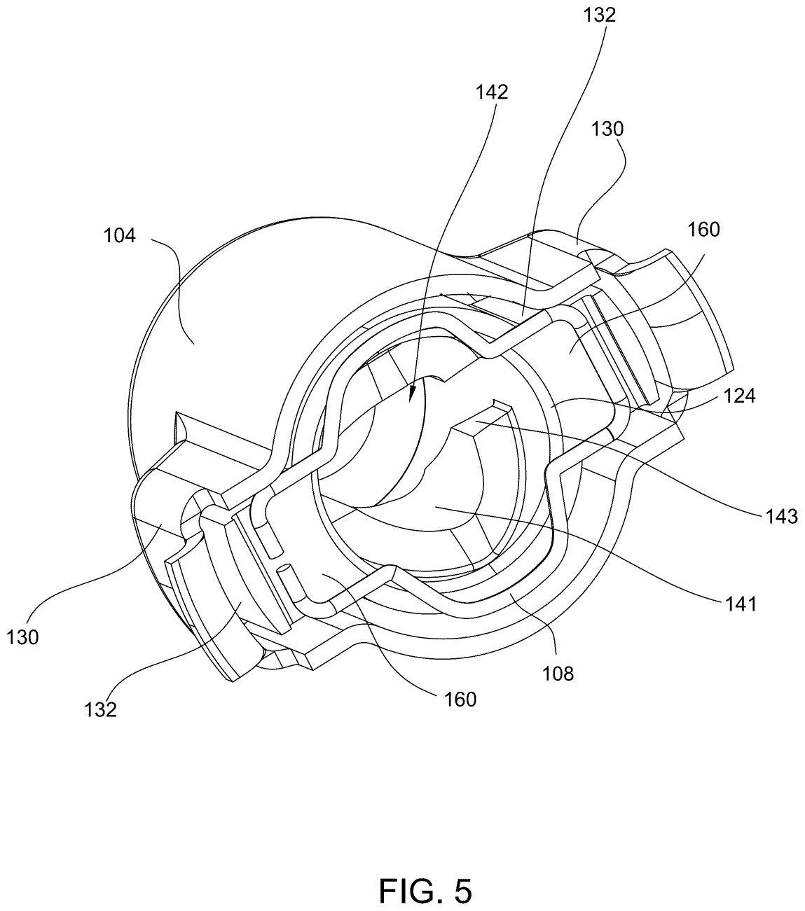

Referring to FIGS. 4 and 5, in the example, the nut plate assembly 100 is configured to retain both the floating nut 106 and the bias member 108 within the shell 104, which allows for the nut plate assembly 100 to be used as an inseparable assembly. In addition, during use, the nut plate assembly 100 requires no access from the nut side of nut plate assembly 100, which is advantageous for use with panels and other structure where access to both sides of the nut plate assembly 100 is limited.

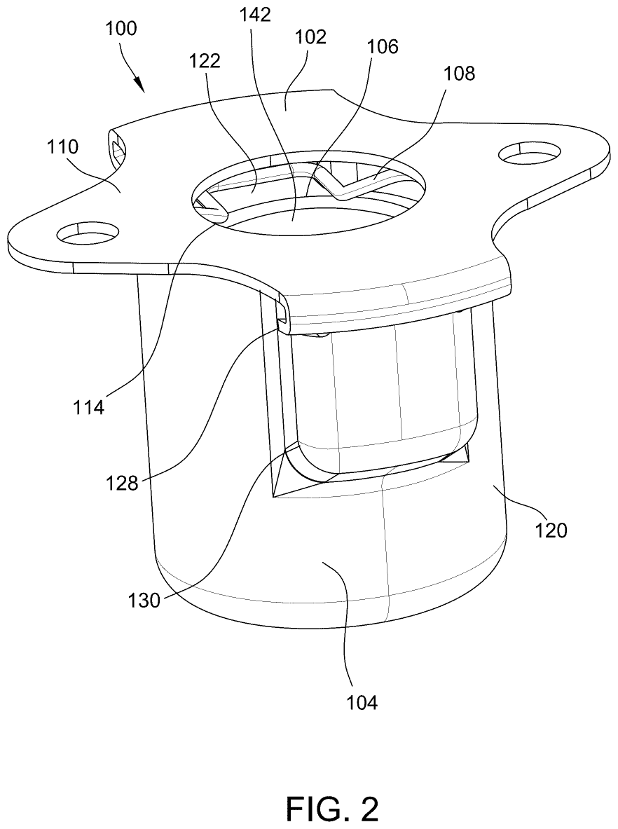

With reference to FIGS. 1-5, the shell 104 includes a first end 116, a second end 118, and a sidewall 120. The sidewall 120 defines a cavity 122 and an opening 124 at the first end 116. The shell 104 is attached to the plate 102 at the first end 116 such that the sidewall 120 extends outward from the plate 102. As seen in FIG. 2, the plate 102 secures the floating nut 106 within the shell 104. In the example, the shell 104 is not permanently coupled to the plate 102 and the shell 104 may be removable from the plate 102. For example, the shell 104 includes flanges 126 that are engaged with retention tabs 128 on the plate 102. In other examples, the shell 104 and/or the plate 102 includes retention tabs or other coupling mechanisms to secure the shell 104 to the plate 102. For example, in some embodiments, the nut plate assembly 100 includes, without limitation, a spring, a hinge, a fastener, a clamp, and adhesive. In another example, the nut plate assembly 100 is integrally formed with or permanently affixed to the plate 102 such that the shell 104 and the plate 102 cannot be separated without damaging the nut plate assembly 100.

As illustrated in FIGS. 5-9, the sidewall 120 of the shell 104 is shaped to enclose and retain the floating nut 106 on the plate 102. For example, at the first end 116, the sidewall 120 is perpendicular to a plane of the plate 102. At the second end 118, the sidewall 120 tapers radially inward, e.g., by a swaging process, to a closed end to facilitate retaining the floating nut 106 within the shell 104 when the shell 104 is coupled to the plate 102. In addition, the shell 104 is shaped to engage and prevent at least some rotation of the floating nut 106. For example, the sidewall 120 includes shoulders 130 that project outward from the cylindrical main body of the shell 104 and define side cavities arranged to receive shoulders 132 on the floating nut 106. The floating nut 106 engages the shoulders 130 of the shell 104 and is fixed against rotation relative to the shell 104.

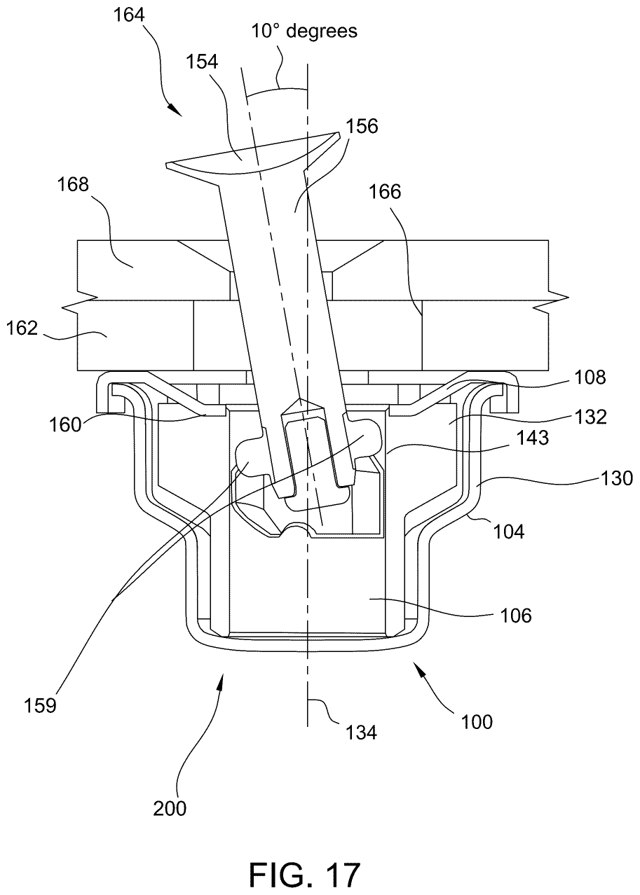

Also, in the example, the floating nut 106 is disposed within the shell 104 and is moveable relative to the sidewall 120. For example, the floating nut 106 is moveable along the center axis 134 of the shell 104 between a first position and a second position. In the first position, the floating nut 106 is proximate the second end 118. In the second position, the floating nut 106 is proximate the first end 116. In another example, the floating nut 106 is moveable between a first position proximate the first end 116 and a second position proximate the second end 118. In addition, in the illustrated example, the floating nut 106 is supported by the bias member 108 at the first end 116 of the shell 104 and the floating nut 106 is tiltable about the center axis 134. The shell 104 inhibits rotation of the floating nut 106 about the center axis 134. Accordingly, in the example, the floating nut 106 is free to move in at least one direction when the floating nut 106 is secured within the cavity 122 of the shell 104. For example, the floating nut 106 is free to move axially within the shell 104 and tilt at an angle relative to the center axis 134 but is inhibited from rotating about the center axis 134, as shown in FIG. 17. The freedom of movement of the floating nut 106 facilitates the floating nut 106 accommodating misalignment of a fastener (e.g., fastener 164 shown in FIGS. 16-20) and the nut plate assembly 100 and/or joining panels with surfaces that are not parallel. The restriction of rotation of the floating nut 106 facilitates the floating nut 106 engaging a fastener 164 and enabling quick and simple securement of the fastener 164 to the nut plate assembly 100.

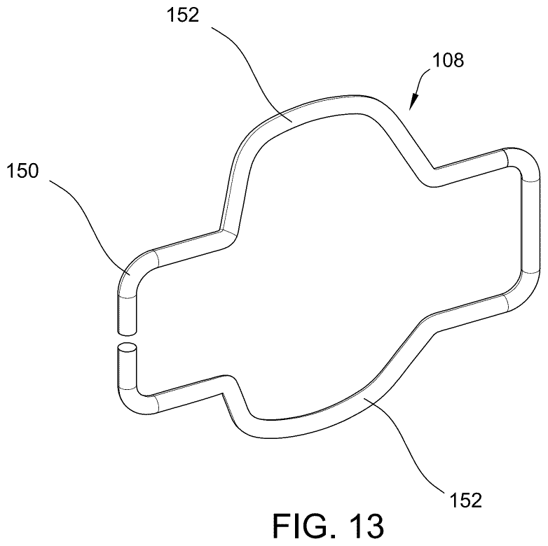

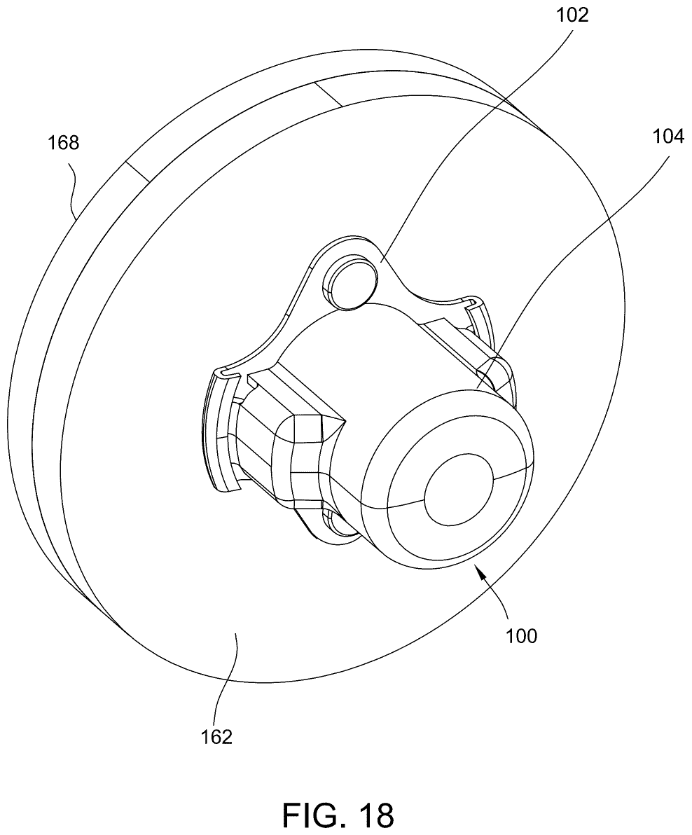

In the example, the bias member 108 is positioned within the shell 104 and between the floating nut 106 and the first end 116 of the shell 104. As such, the bias member 108 biases the floating nut 106 axially away from the plate 102 and towards the second end 118. During use of the nut plate assembly 100, the bias member 108 facilitates the floating nut 106 engaging the fastener 164 (shown in FIG. 18). In the example, the bias member 108 is shaped to provide a desired pre-load force on the floating nut 106, as shown in FIG. 13. Alternatively, the bias member 108 may be any type of bias or force provider that enables nut plate assembly 100 to function as described herein. For example, the bias member 108 may be a compression spring. In some examples, the pre-load force on the floating nut 106 may be adjusted by varying the wire diameter and spring length of the bias member 108. In the example, the characteristics and shape of bias member 108 are selected to provide the necessary pre-load force required for operation of nut plate assembly 100, while maintaining the bias member 108 in an axial resiliency range.

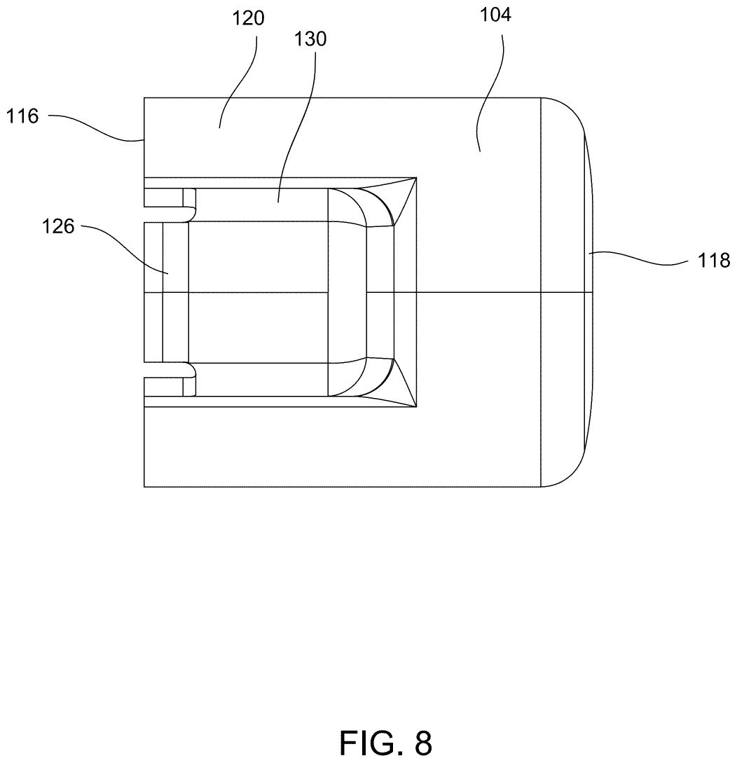

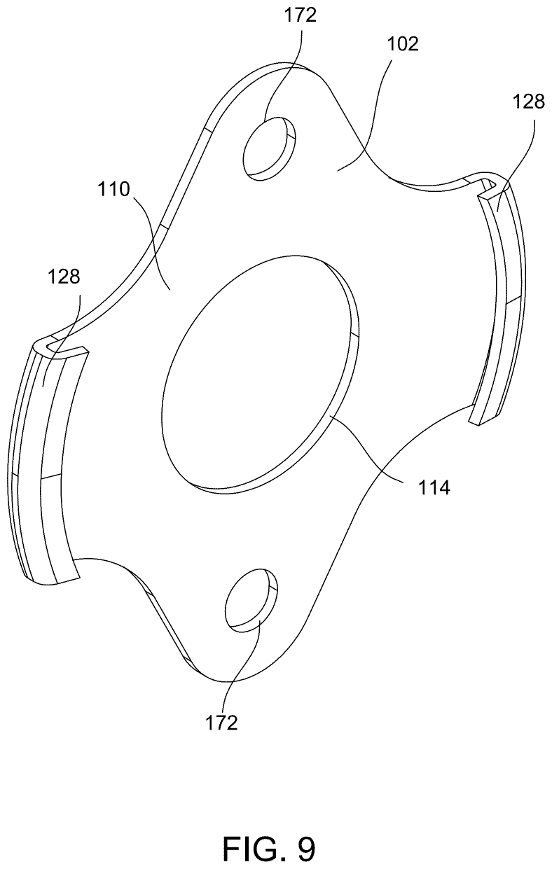

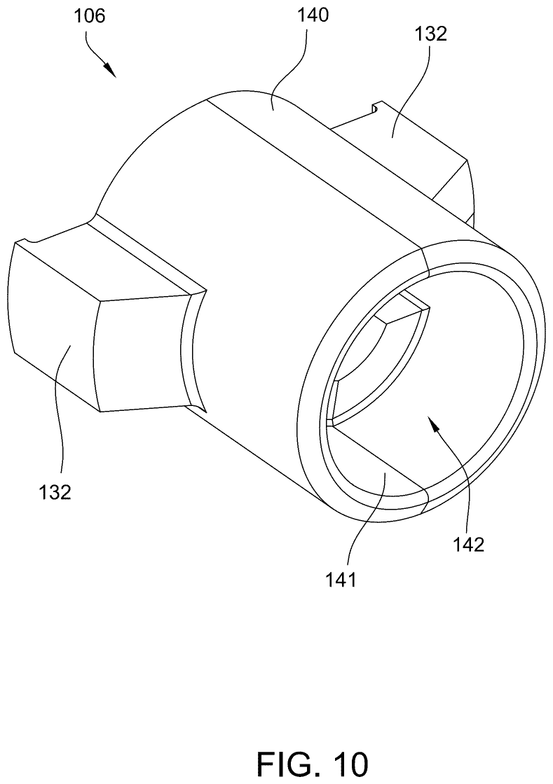

With reference, to FIGS. 10-12, the floating nut 106 has a body 140 that defines an inner bore 142 therethrough. The body 140 includes a first end 144 and a second end 146. The bore 142 extends between and through the first end 144 and the second end 146 of the body 140. At the first end 144 of the body 140, the bore 142 includes a tapered portion configured to facilitate receiving and aligning a fastener 164 (shown in FIGS. 18-20) with the body 140. The body 140 includes an inner surface 141 defining the bore 142 and shaped to receive the fastener 164. In addition, the inner surface 141 defines at least one groove 143 extending along the bore and parallel to the center axis 134. In the example, the floating nut 106 includes a pair of the grooves 143 that are spaced circumferentially apart by 180°.

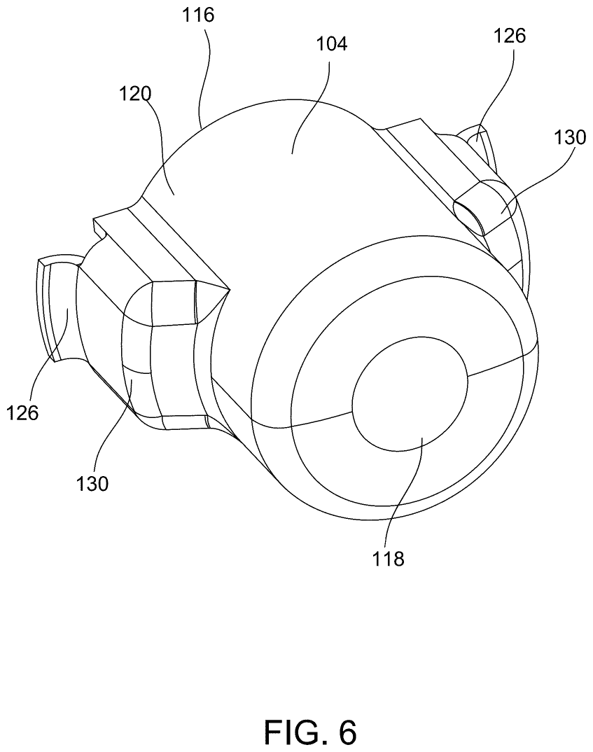

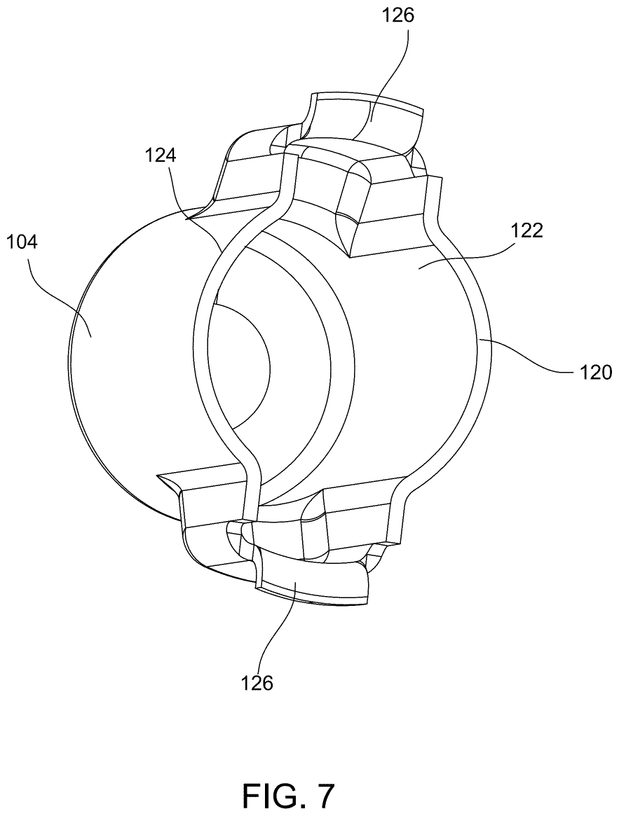

Referring to FIGS. 10-12 and 17, in the example, the floating nut 106 includes two shoulders 132 extending from the second end 146 axially along the center axis 134 a predetermined distance. The shoulders 132 are sized to be received within shoulders 130 of the shell 104 (shown in FIGS. 6 and 7) and engage the shell 104. The shoulders 130 of the shell 104 are longer than the shoulders 132 of the floating nut 106 to facilitate axial movement of the floating nut 106 within the shell 104. The shoulders 130 of the shell 104 and the shoulders 132 are sized and shaped to restrict rotation of the floating nut 106 within the shell 104. For example, the shoulders 132 of the floating nut 106 have a shape that matches the shape of the shoulders 130 of the shell 104 and are only slightly smaller to provide a close fit between the shoulders 132 and the shoulders 130 of the shell 104. Accordingly, the inner surfaces of the shoulders 130 of the shell 104 contact the shoulders 132 of the floating nut 106 and prevent rotation of the floating nut 106 relative to the shell 104.

As shown in FIGS. 5-7, the shoulders 132 of the floating nut 106 define recesses and include bearing surfaces 160 that are shaped to receive the bias member 108. In the example, the bearing surfaces 160 are sized to prevent over-stressing and/or damaging the bias member 108 when the bias member 108 is compressed, while enabling the bias member 108 to urge the body 140 away from the plate 102 when extended. The shoulders 132 and the bearing surfaces 160 enable the bias member 108 to apply an axial force to the body 140 to urge the body 140 away from the plate 102.

In one example, the floating nut 106 is a single piece. In another example, the floating nut 106 includes at least two pieces. For example, the bore 142 and/or the bearing surfaces 160 may be defined by an insert, a washer, and/or another member that is coupled to body 140 of the floating nut 106.

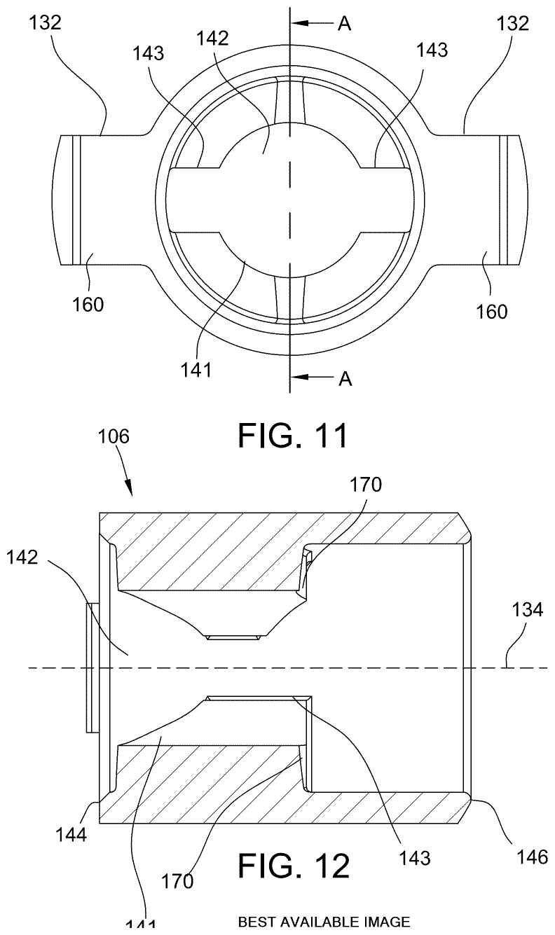

As seen in FIGS. 5 and 11, in the example, the sidewall 120 of the shell 104 defines a cross-sectional shape of the shell 104 and is configured to engage the floating nut 106. The shell 104 and the floating nut 106 define a gap therebetween that is sized to allow axial movement of the floating nut 106 and tilting of the floating nut 106 relative to the shell 104. The shoulders 132 of the floating nut 106 are received within the shoulders of the shell 104 and prevent rotation of the floating nut 106 relative to the shell 104. Accordingly, the sidewall 120 of the shell 104 engages the floating nut 106 within the shoulders to inhibit rotation of the floating nut 106 when the floating nut 106 is positioned within the shell 104. In the example, the cross-sectional shape of the shell 104 is a cylinder with the shoulders extending outward from the cylinder. The shell 104 may be other shapes without departing from some aspects of the disclosure. For example, in some examples, the shell 104 includes, without limitation, a cylinder, a triangle, a rectangle, a trapezoid, a pentagon, a hexagon, a heptagon, an octagon, a nonagon, a decagon, a dodecagon, and a star.

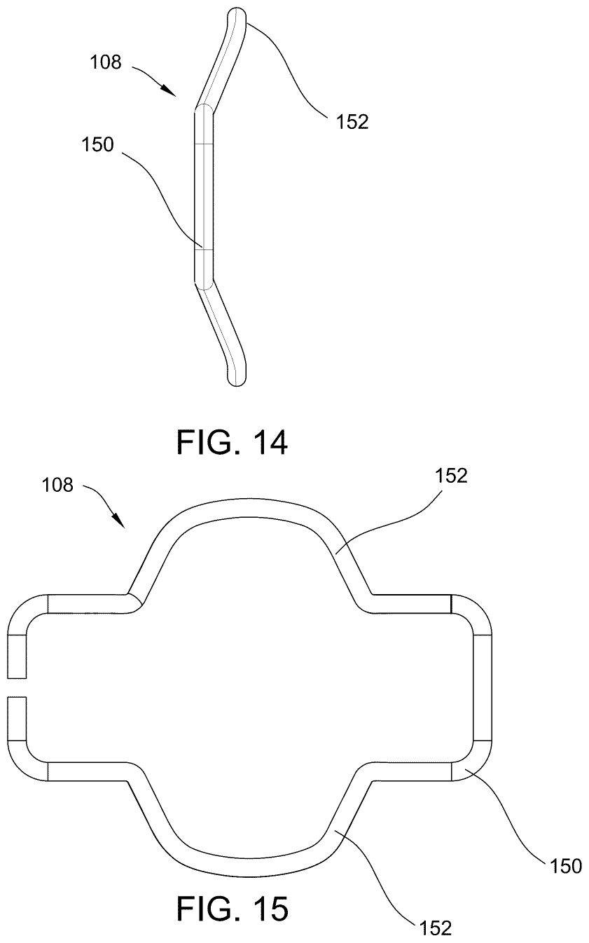

Referring to FIGS. 5 and 13-15, in the example, the bias member 108 is formed of a flexible and resilient wire. The bias member 108 is sized and shaped to be received within the shell 104 and engage the floating nut 106 to provide a desired bias force to the floating nut 106. For example, the bias member 108 comprises an open spring structure including a planar portion forming a main body 150 and angled portions forming wings 152 extending outward from the main body 150. The main body 150 is in a plane and the wings 152 extend at an angle relative to the plane of the main body 150. In example, the bias member 108 is an open structure in which the middle portions of the main body 150 and the wings 152 are open. In other embodiments, the bias member 108 may include one or more flexible plates or other structures that cover at least some of the structure and/or form a part of the planar or angled portions.

In the illustrated example, the bias member 108 is disposed between the plate 102 (shown in FIG. 1) and the floating nut 106, and is configured to bias the floating nut 106 towards the second end 118 of the shell 104. For example, the main body 150 engages the bearing surfaces 160 of the floating nut 106 and the wings 152 engage the plate 102. The wings 152 are compressed or bent when an axial force is applied to the floating nut 106 to facilitate the floating nut 106 moving toward the plate 102. The bias member 108 is resilient and returns to its original shape and maintains a predetermined distance between the floating nut 106 and the plate 102 when the axial force is removed.

With reference to FIGS. 16 and 17, the nut plate assembly 100 is arranged to receive and engage the fastener 164. For example, the fastener 164 extends through the aperture in the plate 102 and engages the floating nut 106. The floating nut 106 is able to tilt relative to the center axis 134 to accommodate misalignment of the fastener 164 relative to the center axis 134 of the nut plate assembly 100. For example, the floating nut 106 can tilt up to 10° relative to the center axis 134 to accommodate angular misalignment. In addition, the nut plate assembly 100 can also accommodate axial misalignment.

Referring to FIGS. 16-20, the fastener 164 includes a head 154, a shank 156 extending axially from the head 154, and at least one protuberance 159 extending outward from the shank 156 at an axial distance from the head 154. The fastener 164 is rotatable relative to the floating nut 106 between a locked orientation and an unlocked orientation. In the example, the fastener 164 is rotatable 90° (a quarter-turn) between the locked orientation and the unlocked orientation. As result, the fastener 164 (and nut plate assembly 100 shown in FIG. 1) provide a locking arrangement that facilitates quickly and simply securing components using the fastener assembly. For example, fastener 164 needs to be rotated less than a full turn (e.g . . . a quarter-turn) to move into the locked position. In addition, an installer may recognize that the fastener 164 is in a fully locked position when the head 154 of the fastener 164 is turned. In contrast, conventional fasteners must be repeatedly rotated multiple turs to achieve a desired tightness and it is unclear if the Examiner has fully locked the fastener after multiple turns.

In the unlocked orientation, the shank 156 of the fastener 164 is able to move axially through the bore 142 of the floating nut 106. For example, the protuberances 159 extend through the axial grooves 143 along the inner surface 141 of the floating nut 106. The grooves 143 are sized to receive the protuberances. For example, the grooves 143 each have a width that is larger than a width of the protuberances 159.

The floating nut 106 includes at least one engagement surface 170 that contacts and engages the protuberances 159 of the fastener 164 when the fastener 164 is in the locked orientation. In the example, the floating nut 106 includes a pair of engagement surfaces 170. For example, each engagement surface 170 is an annular surface or ledge that extends radially outward from the inner surface 141 of the floating nut 106 and circumferentially between the grooves 143. The engagement surfaces 170 extend at an angle relative to the inner surface 141 of the floating nut 106. For example, the engagement surfaces 170 are perpendicular to the inner surface 141 of the floating nut 106. In the example, the engagement surfaces 170 form a ledge adjacent to the inner surface 141 of the floating nut 106. The wall 110 extends beyond the ledge formed by the engagement surfaces 170. The engagement surfaces 170 each engage a respective one of the protuberances 159 and prevent the fastener from moving axially relative to the floating nut 106.

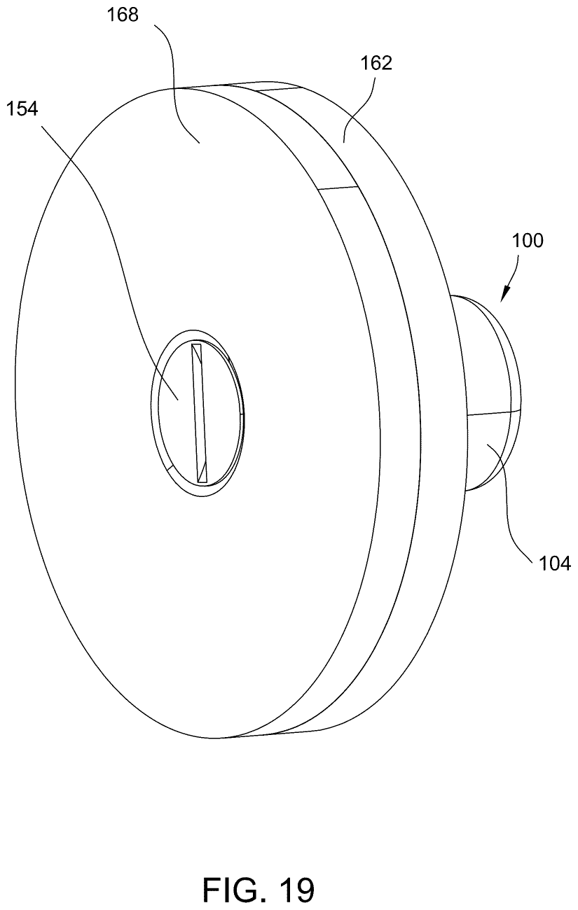

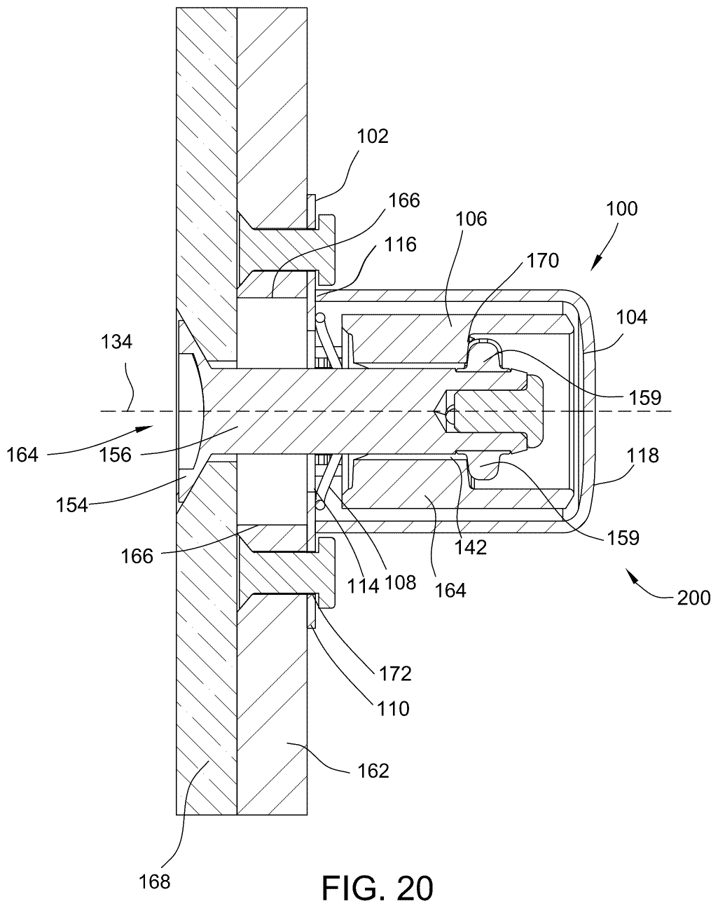

FIGS. 18 and 19 are perspective views of the nut plate assembly 100 installed and used to couple a panel 168 to a mounting structure 162 via the captive fastener 164. FIG. 20 is a cross-sectional view of the nut plate assembly 100 secured to the mounting structure 162 and the panel 168. In the example, the plate 102 of the nut plate assembly 100 is mechanically coupled to the mounting structure 162 by fasteners such as, for example, and without limitation, nut and bolt combinations, sheet metal fasteners, rivets, and the like. In another example, the nut plate assembly 100 is coupled to the mounting structure 162 by, for example, and without limitation, adhesive bonding or any other suitable bonding materials.

The mounting structure 162 includes an aperture 166 defined therethrough and sized to receive at least a portion of the fastener 164. The fastener 164 also extends through the aperture 166 of the panel 168. The nut plate assembly 100 is secured to the mounting structure 162 such that the aperture 114 of the plate 102 is aligned with the aperture 166 of the mounting structure 162 and the nut plate assembly 100 is arranged to receive the fastener 164 protruding from the aperture 166. In some examples, the nut plate assembly 100 includes, for example, and without limitation, a retaining ring, an E-clip, a spring plunger, and/or any mechanism configured to facilitate capturing the fastener 164 in the panel 168.

In the example, the fastener 164 is a panel bolt having the head 154 as shown in FIG. 16. Alternatively, the fastener 164 is any type of fastener having the head 154 taking any shape or form, including for example, and without limitation, a hexagonal head, a spline head, a flat head, a socket cap head, and a pan head or a headless fastener. In some examples, the fastener 164 is a locking fastener, including one or more components configured to lock fastener 164 against rotation relative to panel 168.

The panel 168, with the fastener 164, is introduced to the mounting structure 162 with the nut plate assembly 100 secured on the mounting structure 162. The fastener 164 is aligned with the floating nut 106 and the panel 168 and introduced into the nut plate assembly 100. The bias member 108 is arranged to bias the floating nut 106 toward the mounting structure 162 to provide a preload of the floating nut 106. In addition, the floating nut 106 can tilt or move radially relative to the center axis 134 to accommodate if the fastener 164 is positioned at angle or off-axis relative to the center axis 134. The fastener 164 is pushed toward the mounting structure 162 until the fastener 164 moves through the bore 142 of the floating nut 106 and the protuberances of the fastener 164 move through and beyond the grooves 143 of the floating nut 106. The fastener 164 is rotated from the unlocked orientation to the locked orientation and the protuberances 159 engage the engagement surfaces 170 of the floating nut 106 to secure the panel 168 and the mounting structure 162 together. In the locked orientation, the engagement surfaces 170 engage the protuberances 159 and prevent the fastener 164 from moving axially relative to the floating nut 106. In some examples, the engagement surfaces 170 are shaped to resist rotation of the fastener 164 and maintain the fastener 164 in the locked orientation until a suitable force is delivered to the fastener 164 and/or the floating nut 106. For example, in the illustrated embodiment, due to the position of the bias member, the engagement surfaces 170 are biased toward the protuberances 159 and provide a force on the fastener 164 to prevent movement of the fastener 164 relative to the floating nut 106.

To release the fastener 164, the fastener 164 is rotated from the unlocked orientation to the unlocked orientation. In the unlocked orientation, the protuberances 159 of the fastener 164 are able to move axially through the grooves and the fastener 164 may be removed from the floating nut 106.

In the example, the fastener 164 may rotate in a clockwise or counterclockwise direction to move between the unlocked orientation and the locked orientation. In other examples, the fastener 164 is rotated in one direction to move from the unlocked orientation to the locked orientation and rotated in the opposite direction to move from the locked orientation to the unlocked orientation. In further examples, the fastener 164 is rotated in a single direction to move between the unlocked orientation and the locked orientation.

To assemble the nut plate assembly 100, the bias member 108 and the floating nut 106 are placed into the shell 104 and the plate 102 is coupled to the shell 104 to capture the bias member 108 and the floating nut 106. The bias member 108 engages the plate 102 and the floating nut 106 and is compressed within the shell 104. The opening 124 of the shell 104 is aligned with the aperture 114 of the plate 102, and arranged to receive the fastener 164. In the example, the aperture 114 is oversized in comparison to the fastener 164 (i.e., the aperture 114 is larger than a size necessary to accommodate the diameter of the fastener). Accordingly, the aperture 114 facilitates accommodating increased off-axis engagement of the fastener 164 in the nut plate assembly 100.

The fastener 164 may be captured in the nut plate assembly 100 to form a fastener assembly 200. For example, the fastener 164 is positioned through the aperture 114 of the plate 102, the opening 124 of the shell 104, and into the bore 142 of the floating nut 106. The fastener 164 is moved through bore 142 in the unlocked orientation such that the protuberance 159 of the fastener 164 is moved through the groove 143 until the protuberance 159 is beyond the groove 143. The fastener 164 is then rotated from the unlocked orientation to the locked orientation and the protuberance(s) 159 of the fastener 164 engages the engagement surfaces 170 of the floating nut 106. The bias member 108 biases the floating nut 106 toward the second end 118 of the shell 104 to facilitate engagement of the floating nut 106 and the fastener 164 and secure the fastener 164 in position. For example, the floating nut 106 is biased such that the engagement surfaces 170 of the floating nut 106 are pressed against the protuberance 159 of the fastener 164. The engagement surfaces 170 may be shaped to inhibit rotation of the fastener 164 and prevent the fastener 164 from moving to the unlocked orientation unless a predetermined force is provided to the fastener 164.

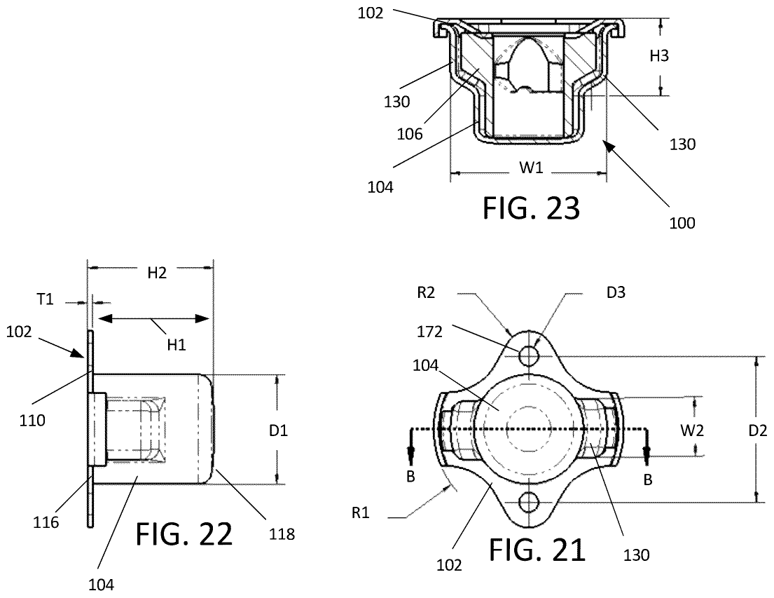

FIGS. 21-23 illustrates example dimensions of a nut plate

assembly (e.g., nut plate assembly 100). FIG. 23 is a cross-sectional view of the nut plate assembly taken along line A-A in FIG. 21. For example, the nut plate assembly 100 has an overall height H1 measured from a bottom surface of the plate 102 to the second end 118 of the shell 104. The shell 104 has a diameter D1 at the second end 118 of the shell 104 and a height H2 measured from the first end 116 to the second end 118 of the shell 104. Also, the shell 104 has a width W1 at the shoulders 132 that is larger than the diameter D1 at the second end 118 of the shell 104. The shoulders 132 have a height H3 that is less than the height H1 of the shell 104. Also, the shoulders 132 each have a width W2 that is less than the diameter D1 of the shell 104. Accordingly, the shoulders 132 are shaped to engage the floating nut 106 and prevent rotation of the floating nut 106 while facilitating axial movement and tilting of the floating nut 106.

In addition, the plate 102 is shaped to be secured to or otherwise affixed to a substrate and to receive the shell 104 and floating nut 106. For example, the plate 102 includes openings 172 spaced apart a distance D2 and positioned on opposite sides of the shell 104 when the shell 104 is coupled to the plate 102. The openings 172 have a diameter D3 that is sized to receive fasteners or other securement devices. In addition, sides of the plate 102 adjacent the shoulders 132 of the shell 104 may be curved with a radius R1 that matches a radius of at least one curve on the shell 104. The sides of the plate 102 adjacent the openings 172 may be curved with a radius R2 that is smaller than the radius R1 such that the plate 102 projects outward and accommodates the openings 172. Also, the plate 102 has a thickness T1 that facilitates the plate 102 supporting the floating nut 106 and the shell 104. In other embodiments, the plate 102 may have any suitable shape. For example, in some embodiments, the openings 172 are omitted and the plate 102 is bonded to the structure or panel.

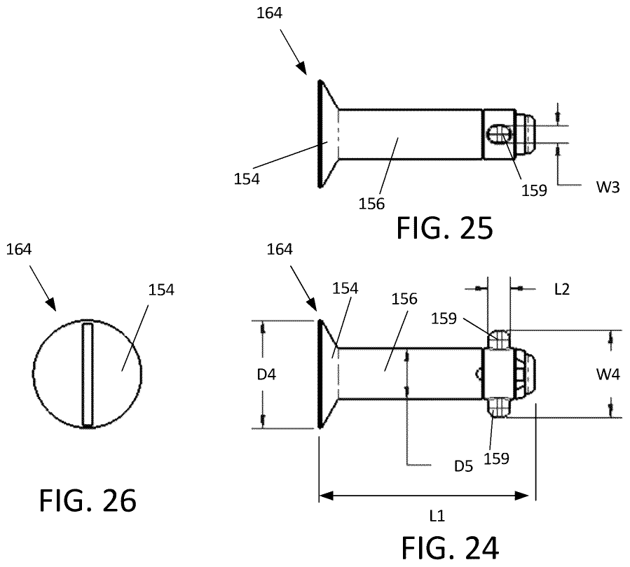

FIGS. 24-26 illustrates example dimensions and shapes of a fastener (e.g., fastener 164). The fastener 164 is sized to extend through and engage a nut plate assembly (e.g., the nut plate assembly 100 shown in FIGS. 21-23). For example, the fastener 164 has a length L1 measured from the head 154 to an end of the fastener 164. The head 154 has a diameter D4, and the shank 156 has a diameter D5.

The protuberances 159 extend radially outward from the shank 156 and are sized to engage the floating nut 106 (shown in FIGS. 21-23). For example, the protuberances have an axial length L2 and a width W3. In addition, the fastener 164 has width W4 at the protuberances 159 that is less than the diameter D4 of the head 154. The fastener 164 is sized to fit through a groove in a nut plate assembly in an unlocked orientation and engage engagement surfaces in a locked orientation.

In a first example, a nut plate assembly comprises a plate comprising an aperture defined therethrough; a shell attached to the plate and extending along a center axis; and a nut retained within the shell and comprising an inner surface and an engagement surface that extends at an angle relative to the inner surface, the inner surface defining an inner bore and having a groove extending along the inner bore and parallel to the center axis, wherein the nut plate assembly is configured to receive a fastener extending through the aperture of the plate and into the inner bore in the nut, wherein in an unlocked orientation, the fastener is configured to move through the groove, and wherein in a locked orientation, the engagement surface engages the fastener and prevents the fastener moving axially relative to the floating nut.

In a second example, the fastener is rotated within the inner bore between the locked orientation and the unlocked orientation.

In a third example, the unlocked orientation and the locked orientation are 90° apart.

In a fourth example, the groove is sized to receive a protuberance on the fastener, and wherein the engagement surface is configured to engage the protuberance when the nut plate assembly is in the locked orientation.

In a fifth example, a bias member is disposed within the shell and engaged with the nut, wherein the bias member is disposed between the plate and the nut and is configured to bias the nut towards an end of the shell.

In a sixth example, the nut is tiltable within the shell and relative to the center axis to engage the fastener if the fastener extends at an angle relative to the center axis.

In a seventh example, the nut is able to move axially within the shell and is fixed against rotation relative to the shell.

In an eighth example, the nut includes a first end, a second end, and a shoulder, the shoulder is shaped to engage the shell and fix the nut against rotation within the shell.

In a ninth example, a fastener assembly comprises a plate comprising an aperture defined therethrough; a shell attached to the plate and extending along a center axis; a nut retained within the shell and comprising an inner bore; a fastener extending through the plate and into the shell to engage the nut; and a bias member disposed within the shell and engaged with the nut, wherein the fastener is rotatable between an unlocked orientation and a locked orientation when the fastener is engaged with the nut, the nut includes an engagement surface that engages the fastener when the fastener is in the locked orientation, wherein the unlocked orientation and the locked orientation are 90° apart.

In a tenth example, the nut includes an inner surface defining the inner bore, the inner surface having a groove extending along the inner bore and parallel to the center axis.

In an eleventh example, the fastener includes a protuberance sized to move through the groove, wherein the protuberance engages the engagement surface of the nut when the fastener is in the locked orientation.

In a twelfth example, the bias member is disposed between the plate and the nut, and is configured to bias the nut towards an end of the shell.

In a thirteenth example, the nut is tiltable within the shell and relative to the center axis to engage the fastener if the fastener extends at an angle relative to the center axis.

In a fourteenth example, the nut includes a first end, a second end, and a shoulder, the shoulder is shaped to engage the shell and fix the nut against rotation within the shell.

In a fifteenth example, the first end of the nut has a recess arranged to receive the bias member.

In a sixteenth example, the bias member comprises a wire spring formed of a flexible and resilient wire.

In a seventeenth example, the bias member includes a main body and wings extending outward from the main body.

In an eighteenth example, a method of assembling a nut plate assembly comprises positioning a nut within a shell extending along a center axis, the nut comprising an inner surface and an engagement surface that extends at an angle relative to the inner surface, the inner surface defining an inner bore and having a groove extending along the inner bore and parallel to the center axis; and coupling a plate to the shell to capture the nut within the shell, the plate comprising an aperture arranged to receive a fastener such that the fastener extends through the plate and into the shell to engage the nut, wherein in an unlocked orientation, the fastener is configured to move through the groove, and wherein in a locked orientation, the engagement surface engages the fastener and prevents the fastener moving axially relative to the floating nut.

In a nineteenth example, a method includes positioning a bias member within a shell, the nut configured to engage the bias member, wherein the bias member is arranged to bias the nut toward an end of the shell, and wherein the nut is tiltable within the shell and relative to the center axis to engage the fastener if the fastener extends at an angle relative to the center axis.

In a twentieth example, a method includes fixing the nut against rotation within the shell, wherein the fastener is rotatable relative to the nut between an unlocked orientation and a locked orientation when the fastener is engaged with the nut, the nut includes an engagement surface that engages the fastener when the fastener is in the locked orientation.

The components as described herein provide spring-loaded nut plate assemblies. For example, as described in the embodiments herein, a floating nut of the nut plate assemblies is biased by a bias member, which enables the use of captive panel screws. This facilitates ease of assembly and disassembly of a panel to an underlying structure. In addition, the spring-loaded nut plate assemblies facilitate the nut plate assembly accommodating varying lengths of captive panel fasteners. The bias member facilitates one of pulling the structure components together or pushing them apart during assembly or removal of the panel structure.

The nut plate assemblies facilitate engagement with fasteners extending at an angle relative to a center axis or axially offset from the center axis. In addition, the nut plate assemblies provide a secure and simple engagement of the fastener and the nut plate assemblies. Moreover, the nut plate assemblies and fasteners do not require threads or complicated components that may be damaged due to improper handling or installation. As a result, the nut plate assemblies provide a reliable manner to secure components together and reduces time and effort required for assembly.

Examples of spring-loaded nut plate assemblies are described above. The systems and methods are not limited to the specific embodiments described herein, but rather, components of the systems and/or operations of the methods may be utilized independently and separately from other components and/or operations described herein. Further, the described components and/or operations may also be defined in, or used in combination with, other systems, methods, and/or devices, and are not limited to practice with only the systems described herein.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A nut plate assembly comprising:
a plate comprising an aperture defined therethrough;
a shell attached to the plate and extending along a center axis; and
a nut retained within the shell and comprising an inner surface and an engagement surface that extends at an angle relative to the inner surface, the inner surface defining an inner bore and having a groove extending along the inner bore and parallel to the center axis,
wherein the nut plate assembly is configured to receive a fastener extending through the aperture of the plate and into the inner bore in the nut,
wherein in an unlocked orientation, the fastener is configured to move through the groove, and
wherein in a locked orientation, the engagement surface of the nut engages the fastener and prevents the fastener moving axially relative to the nut.

2. A nut plate assembly in accordance with claim 1, wherein the fastener is rotated within the inner bore between the locked orientation and the unlocked orientation.

3. A nut plate assembly in accordance with claim 2, wherein the unlocked orientation and the locked orientation are 90° apart.

4. A nut plate assembly in accordance with claim 1, wherein the groove is sized to receive a protuberance on the fastener, and wherein the engagement surface is configured to engage the protuberance when the nut plate assembly is in the locked orientation.

5. A nut plate assembly in accordance with claim 1, further comprising a bias member disposed within the shell and engaged with the nut, wherein the bias member is disposed between the plate and the nut and is configured to bias the nut towards an end of the shell.

6. A nut plate assembly in accordance with claim 5, wherein the nut is tiltable within the shell and relative to the center axis to engage the fastener if the fastener extends at an angle relative to the center axis.

7. A nut plate assembly in accordance with claim 1, wherein the nut is able to move axially within the shell and is fixed against rotation relative to the shell.

8. A nut plate assembly in accordance with claim 7, wherein the nut includes a first end, a second end, and a shoulder, the shoulder is shaped to engage the shell and fix the nut against rotation within the shell.

9. A fastener assembly comprising:
a plate comprising an aperture defined therethrough;
a shell attached to the plate and extending along a center axis;
a nut retained within the shell and comprising an inner bore;
a fastener extending through the plate and into the shell to engage the nut; and
a bias member disposed within the shell and engaged with the nut,
wherein the fastener is rotatable between an unlocked orientation and a locked orientation when the fastener is engaged with the nut, the nut includes an engagement surface that engages the fastener when the fastener is in the locked orientation, wherein the unlocked orientation and the locked orientation are 90° apart.

10. A fastener assembly in accordance with claim 9, wherein the nut includes an inner surface defining the inner bore, the inner surface having a groove extending along the inner bore and parallel to the center axis.

11. A fastener assembly in accordance with claim 10, wherein the fastener includes a protuberance sized to move through the groove, wherein the protuberance engages the engagement surface of the nut when the fastener is in the locked orientation.

12. A fastener assembly in accordance with claim 9, wherein the bias member is disposed between the plate and the nut, and is configured to bias the nut towards an end of the shell.

13. A fastener assembly in accordance with claim 9, wherein the nut is tiltable within the shell and relative to the center axis to engage the fastener if the fastener extends at an angle relative to the center axis.

14. A fastener assembly in accordance with claim 9, wherein the nut includes a first end, a second end, and a shoulder, the shoulder is shaped to engage the shell and fix the nut against rotation within the shell.

15. A fastener assembly in accordance with claim 14, wherein the first end of the nut has a recess arranged to receive the bias member.

16. A fastener assembly in accordance with claim 9, wherein the bias member comprises a wire spring formed of a flexible and resilient wire.

17. A fastener assembly in accordance with claim 9, wherein the bias member includes a main body and wings extending outward from the main body.

18. A method of assembling a nut plate assembly, said method comprising:
positioning a nut within a shell extending along a center axis, the nut comprising an inner surface and an engagement surface that extends at an angle relative to the inner surface, the inner surface defining an inner bore and having a groove extending along the inner bore and parallel to the center axis; and
coupling a plate to the shell to capture the nut within the shell, the plate comprising an aperture arranged to receive a fastener such that the fastener extends through the plate and into the shell to engage the nut,
wherein in an unlocked orientation, the fastener is configured to move through the groove, and
wherein in a locked orientation, the engagement surface engages the fastener and prevents the fastener moving axially relative to the nut.

19. A method in accordance with claim 18, further comprising positioning a bias member within a shell, the nut configured to engage the bias member, wherein the bias member is arranged to bias the nut toward an end of the shell, and wherein the nut is tiltable within the shell and relative to the center axis to engage the fastener if the fastener extends at an angle relative to the center axis.

20. A method in accordance with claim 18, further comprising fixing the nut against rotation within the shell, wherein the fastener is rotatable relative to the nut between an unlocked orientation and a locked orientation when the fastener is engaged with the nut, the nut includes an engagement surface that engages the fastener when the fastener is in the locked orientation.
